(19) United States
(12) Patent Application Publication
(10) Pub. No.: US 2014/0272623 A1
(43) Pub. Date: Sep. 18, 2014

(54) SYSTEM FOR INCREASING EFFICIENCY OF SEMICONDUCTOR PHOTOCATALYSTS EMPLOYING A HIGH SURFACE AREA SUBSTRATE

(71) Applicant: Sunpower Technologies LLC, (US)

(72) Inventor: Travis Jennings, San Diego, CA (US)

(73) Assignee: Sunpower Technologies LLC, San Marcos, CA (US)

(21) Appl. No.: 13/833,457

(22) Filed: Mar. 15, 2013

(51) Int. Cl. H01M 8/06; B01J 19/12

(52) U.S. Cl. CPC H01M 8/0687; B01J 19/127; H01M 8/0656
USPC 429/411; 422/186.04

(57) ABSTRACT

A system for energy production may include a photoactive material with photocatalytic capped colloidal nanocrystals (PCCN) and plasmonic nanoparticles over a high surface area gridded substrate for increasing light harvesting efficiency. The formation of PCCN may include a semiconductor nanocrystal synthesis and an exchange of organic capping agents with inorganic capping agents. Additionally, the PCCN may be deposited between the plasmonic nanoparticles, and may act as photocatalysts for redox reactions. The photoactive material may be used in a plurality of photocatalytic energy conversion applications such as water splitting or CO₂ reduction. Higher light harvesting and energy conversion efficiency may be achieved by combining the plasmonic nanoparticles and PCCN over the high surface area gridded substrate. The system may also include elements necessary to collect, transfer and store hydrogen and oxygen, for subsequent transformation into electrical energy.

### CROSS-REFERENCE TO RELATED APPLICATIONS

The disclosure here described is related to the invention disclosed in the U.S. application No. (not yet assigned), entitled “Photo-catalytic Systems for the Production of Hydrogen”.

### BACKGROUND

1. Field of the Disclosure

The present disclosure relates generally to photocatalysis, and more specifically to a photocatalytic system for energy generation employing an enhanced photoactive material over a high surface area substrate.

2. Background Information

Photoactive materials used in photocatalytic reactions, such as water splitting and CO₂ reduction may require having a strong UV/visible light absorption, high chemical stability in the dark and under illumination, suitable band edge alignment to enable redox reactions, efficient charge transport in the semiconductors, and low over potentials for redox reactions.

Methods for fabricating photoactive materials from semiconductor nanoparticles for photocatalytic reactions also include the use of colloidal nanoparticles with organic, volatile ligands, which have insulating characteristics that may prevent a good separation of charge carriers for use in redox reactions, reducing light harvesting and energy conversion efficiencies. Furthermore, current substrates, such as planar substrates, used for depositing the nanoparticles may not provide enough surface area for the reactions to take place at higher efficiencies.

Efforts to produce photocatalysts operating efficiently under visible light have led to a number of plasmonic photocatalysts, in which noble metal nanoparticles are deposited on the surface of polar semiconductor or insulator particles. In the metal-semiconductor composite photocatalysts, the noble metal nanoparticles act as a major component for harvesting visible light due to their surface plasmon resonance while the metal-semiconductor interface efficiently separates the photo-generated electrons and holes. However, corrosion or dissolution of noble metal particles in the course of a photocatalytic reaction is very likely to limit the practical application of such systems.

It would therefore be desirable to improve existing systems for producing energy using photoactive materials to be used in photocatalytic reactions such as water splitting and CO₂ reduction.

### SUMMARY

According to various embodiments of the present disclosure, a hydrogen and energy generation systems that involve the use of a highly efficient photoactive material combined with a high surface area grid including a wire mesh substrate and piezoelectric actuators, are disclosed. The photoactive material may be employed in the presence of sunlight and water to initiate redox reactions that may split water into hydrogen and oxygen. Additional photocatalytic applications, such as CO₂ reduction, may as well be considered.

The method for producing PCCN may include semiconductor nanocrystals synthesis and substituting organic capping agents with inorganic capping agents. The morphologies of semiconductor nanocrystals may include nanocrystals, nanorods, nanoplates, nanowires, dumbbell-like nanoparticles, and dendritic nanomaterials, among others. Each morphology may include an additional variety of shapes such as spheres, cubes, tetrahedra (tetrapods), among others. Varying sizes and shapes of PCCN may assist in tuning band gaps for absorbing different wavelengths of light.

A preparation of plasmonic nanoparticles may be performed separately from the formation of PCCN, and may include different methods known in the art. Plasmonic nanoparticles may include any suitable shape, such as spherical (nanospheres), cubic (nanocubes), or wires (nanowires), among others. After the preparation of plasmonic nanoparticles, a deposition of PCCN between plasmonic nanoparticles may take place upon suitable substrates. After both PCCN and plasmonic nanoparticles have been deposited on the substrate, a thermal treatment may be performed.

A suitable substrate that may be employed for the deposition of plasmonic nanoparticles and PCCN may be a high surface area grid that may include a wire mesh substrate and piezoelectric actuators. The piezoelectric actuators may enable a precise control over spacing and contact dimensions between neighboring wires of the wire mesh substrate, which may increase efficiency of plasmonic nanoparticles and PCCN on the surface of the wire mesh substrate by increasing the surface area available for interaction with water as well as refreshing static volumes of water in direct contact with the surface of the wire mesh substrate.

When light makes contact with the plasmonic nanoparticles, oscillations of free electrons may occur as a consequence of the formation of a dipole moment in the plasmonic nanoparticles due to action of energy from electromagnetic waves of incident light, leading to LSPR. Additionally, strong electric fields may be created with LSPR. Electric fields of adjacent plasmonic nanoparticles may interact with each other to facilitate charge separation for accelerating redox reactions. The photoactive material may be submerged in water included in a reaction vessel so that a water splitting process may take place. Production of charge carriers may be triggered by photo-excitation and enhanced by the rapid electron resonance from LSPR. When electrons are in conduction band of PCCN, they may reduce hydrogen molecules from water, while oxygen molecules may be oxidized by holes left behind in the valence band of the plasmonic nanoparticles.

A water splitting system employing the water splitting process, may include elements for providing water into the reaction vessel (e.g., a device including a pump, a regulator, a blower, or any combination thereof) and elements for collecting (e.g., a device including a separator, a membrane, a filter, or any combination thereof) the hydrogen and oxygen gases produced.

Additionally, an energy generation system including the water splitting system, may include storage of hydrogen and oxygen gases in different containers, to be later used as a carbon neutral fuel source. In some cases, the hydrogen and oxygen gases produced may be converted to water using a secondary device, for example, an energy conversion device such as a fuel cell. An energy conversion device, in some embodiments, may be used to provide at least a portion of the energy required to operate an automobile, a house, a village, a cooling device (e.g., a refrigerator), or any other electrically driven applications.

The structure of PCCN may speed up redox reactions by quickly transferring charge carriers sent by plasmonic nanoparticles to water. In addition, there may be a higher production of electrons and holes being used in redox reactions, since PCCN within the photoactive material may be designed to separate holes and electrons immediately upon the accelerated formation by plasmonic nanoparticles triggered by LSPR, thus reducing the probability of electrons and holes recombining. Combining the PCCN and plasmonic nanoparticles with the high surface area grid substrate described in the present disclosure may further increase efficiency of photocatalytic reactions, such that redox reactions in, for example, water splitting or CO₂ reduction, may occur at a faster and more efficient rate. Additionally, high surface area of PCCN may also enhance efficiency of light absorption and of charge carrier dynamics.

In one embodiment, a photoactive material comprises a substrate, wherein the substrate comprises: a first set of substantially parallel wires extending in a first direction; a first piezoelectric actuator coupled to the first set of wires at a first end of the first set of wires; a second piezoelectric actuator coupled to the first set of wires at a second end of the first set of wires; a second set of substantially parallel wires extending in a second direction that is perpendicular to the first direction; a third piezoelectric actuator coupled to the second set of wires at a first end of the second set of wires; and a fourth piezoelectric actuator coupled to the second set of wires at a second end of the second set of wires; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles.

In another embodiment, a water splitting system comprises a photoactive material, wherein the photoactive material comprises: a substrate, wherein the substrate comprises: a first set of substantially parallel wires extending in a first direction; a first piezoelectric actuator coupled to the first set of wires at a first end of the first set of wires; a second piezoelectric actuator coupled to the first set of wires at a second end of the first set of wires; a second set of substantially parallel wires extending in a second direction that is perpendicular to the first direction; a third piezoelectric actuator coupled to the second set of wires at a first end of the second set of wires; and a fourth piezoelectric actuator coupled to the second set of wires at a second end of the second set of wires; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles; a reaction vessel housing the photoactive material and configured to receive water through a nozzle and facilitate a water splitting reaction when the water reacts with the photocatalytic capped colloidal nanocrystals and plasmonic nanoparticles, wherein the reaction occurs when the plasmonic nanoparticles absorb irradiated light that causes electrons in the valence band of the plasmonic nanoparticles to migrate into the conduction band of the photocatalytic capped colloidal nanocrystals, and the electrons in the conduction band of the photocatalytic capped colloidal nanocrystals are used to reduce water into hydrogen gas and oxygen gas; a collector connected to the reaction vessel and comprising: a hydrogen-permeable membrane configured to separate the hydrogen from the oxygen in the collector, wherein the hydrogen passes through the hydrogen-permeable membrane into a hydrogen storage; and a oxygen-permeable membrane configured to separate the oxygen from the hydrogen in the collector, wherein the oxygen passes through the oxygen-permeable membrane into an oxygen storage; a fuel cell configured to mix the hydrogen gas received from the hydrogen storage and the oxygen gas received from the oxygen storage to produce water and electricity

In another embodiment, a carbon dioxide reduction system comprises: a photoactive material, wherein the photoactive material comprises a substrate, wherein the substrate comprises: a first set of substantially parallel wires extending in a first direction; a first piezoelectric actuator coupled to the first set of wires at a first end of the first set of wires; a second piezoelectric actuator coupled to the first set of wires at a second end of the first set of wires; a second set of substantially parallel wires extending in a second direction that is perpendicular to the first direction; a third piezoelectric actuator coupled to the second set of wires at a first end of the second set of wires; and a fourth piezoelectric actuator coupled to the second set of wires at a second end of the second set of wires; a plurality of plasmonic nanoparticles deposited on the substrate, wherein the plasmonic nanoparticles create an electric field between two adjacent plasmonic nanoparticles when absorbing light; and a plurality of photocatalytic capped colloidal nanocrystals deposited on the substrate, wherein each photocatalytic capped colloidal nanocrystal is deposited between at least two plasmonic nanoparticles; a reaction vessel housing the photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction occurs when the plasmonic nanoparticles absorb irradiated light that causes electrons in the valence band of the plasmonic nanoparticles to migrate into the conduction band of the photocatalytic capped colloidal nanocrystals; and a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 is a flow diagram of a process for producing a photoactive material including photocatalytic capped colloidal nanocrystals (PCCN) and plasmonic nanoparticles, according to an embodiment.

FIG. 2 illustrates a wire mesh substrate that may be employed for photoactive material, according to an embodiment.

FIG. 3A illustrates vertically aligned wires connected to piezoelectric actuators and horizontally aligned wires connected to piezoelectric actuators, according to an exemplary embodiment and FIG. 3B illustrates a high surface area grid including vertically aligned wires superimposed over horizontally aligned wires, according to an embodiment.

FIG. 4A illustrates plasmonic nanoparticles exhibiting an edge-to-edge nanojunction and FIG. 4B illustrates plasmonic nanoparticles exhibiting a face-to-face nanojunction, according to an embodiment.

FIG. 5A illustrates a PCCN positioned between plasmonic nanoparticles in the edge-to-edge nanojunction and FIG. 5B illustrates a PCCN positioned between plasmonic nanoparticles in the face-to-face nanojunction, according to an embodiment.

FIG. 6 illustrates localized surface plasmon resonance (LSPR) occurring when the photoactive material reacts to light, according to an embodiment.

FIG. 7 depicts a water splitting process that may occur when the photoactive material is submerged in water and makes contact with incident light, according to an embodiment.

FIG. 8A illustrates light contacting plasmonic nanoparticles to excite electrons into the valence band of the plasmonic nanoparticles into the conduction band of the PCCN as part of the charge separation process that may occur during water splitting, and FIG. 8B illustrates electrons reducing hydrogen from water, according to an embodiment.

FIG. 9 shows a water splitting system, according to an embodiment.

FIG. 10 shows an energy generation system that may be used to produce and store hydrogen and oxygen gases for generating electricity, according to an embodiment.

FIG. 11 shows a hydrogen fuel cell that may be used for mixing hydrogen and oxygen gases for the production of electricity and water, according to an embodiment.

FIG. 12 shows a PCCN in spherical shape, according to an embodiment.

FIG. 13 shows a PCCN in rod shape, according to an embodiment.

FIG. 14 illustrates a photoactive material with a high surface area grid for CO2 reduction for producing methane molecules and water, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used herein, the following terms may have the following definitions:

“Semiconductor nanocrystals” refers to particles sized between about 1 and about 100 nanometers made of semiconducting materials.

“Valence band” refers to an outermost electron shell of atoms in semiconductor or metal nanoparticles, in which electrons may be too tightly bound to an atom to carry electric current.

“Conduction band” refers to a band of orbitals that are high in energy and generally empty.

“Band gap” refers to an energy difference between a valence band and a conduction band within semiconductor or metal nanoparticles.

“Inorganic capping agent” refers to semiconductor particles excluding organic materials and which may cap semiconductor nanocrystals.

“Organic capping agent” refers to materials excluding inorganic substances, which may assist in a suspension and/or solubility of a semiconductor nanocrystal in solvents.

“Photoactive material” refers to a substance capable of performing catalytic reactions in response to light.

“Localized surface plasmon resonance”, or LSPR, refers to a phenomenon in which conducting electrons on noble metal semiconductor nanoparticles undergo a collective oscillation induced by an oscillating electric field of incident light.

“Dipole moment” refers to a measure of a separation of positive and negative electrical charges within materials.

“Sensitivity to light” refers to a property of materials that when exposed to photons typically within a visible region, such as of about 400 nm to about 750 nm, LSPR may be excited.

“High surface area grid” refers to a material having a mesh and two or more piezoelectric actuators. Such material may be employed as a substrate in photocatalytic processes.

“Piezoelectric actuator” refers to multilayer devices employed for nano and micro-positioning.

### DESCRIPTION OF THE DRAWINGS

The present disclosure relates to a method of plasmon-induced enhancement of catalytic properties of semiconductor photocatalysts, in which photocatalytic capped colloidal nanocrystals (PCCN) may be deposited between plasmonic nanoparticles within a photoactive material. The plasmonic metal nanoparticles may react to incident light to create a very intense electric field between two adjacent plasmonic metal nanoparticles, initiated by surface plasmon resonance. These intense electric fields may enhance the production of charge carriers by the plasmonic metal nanoparticles for use in redox reactions, such as photocatalytic water splitting or CO₂ reduction, and may improve the catalytic properties of the PCCN.

Both the plasmonic metal nanoparticles and the PCCN may first be produced separately and subsequently combined and deposited on a substrate for forming the photoactive material.

Photoactive Material Formation

FIG. 1 is a flow diagram for a method for forming a photoactive material 100. To form a composition of PCCN that may be included in the photoactive material, semiconductor nanocrystals may first be formed, for which known synthesis techniques via batch or continuous flow wet chemistry processes may be employed. These known techniques may include a reaction of semiconductor nano-precursors with organic solvents 102, which may involve capping semiconductor nanocrystal precursors in a stabilizing organic material, or organic ligands, referred in this description as an organic capping agent, for preventing agglomeration of the semiconductor nanocrystals during and after reaction of semiconductor nano-precursors with organic solvents 102. Additionally, the long organic chains radiating from organic capping agents on the surface of semiconductor nanocrystals may assist in suspending or dissolving those nanocrystals in a solvent. One example of an organic capping agent may be trioctylphosphine oxide (TOPO), which may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after their synthesis. Suitable organic capping agents may also include long-chain aliphatic amines, long-chain aliphatic phosphines, long-chain aliphatic carboxylic acids, long-chain aliphatic phosphonic acids and mixtures thereof.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties or charge carrier mobility. As known in the art, a number of synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be used.

Examples of semiconductor nanocrystals may include the following: AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures thereof. Additionally, examples of applicable semiconductor nanocrystals may further include core/shell semiconductor nanocrystals such as Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O4, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods such as CdSe; core/shell nanorods such as CdSe/CdS; nano-tetrapods such as CdTe, and core/shell nano-tetrapods such as CdSe/CdS.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, tetrahedra (tetrapods), among others. Neither the morphology nor the size of semiconductor nanocrystals may inhibit method for forming a photoactive material 100; rather, the selection of morphology and size of semiconductor nanocrystals may permit the tuning and control of the properties of PCCN. The semiconductor nanocrystals may have a diameter between about 1 nm and about 1000 nm, although typically they are in the 2 nm to 10 nm range. Due to the small size of the semiconductor nanoparticles, quantum confinement effects may manifest, resulting in size, shape, and compositionally dependent optical and electronic properties, versus properties for the same materials in bulk scale.

Following reaction of semiconductor nano-precursors with organic solvents 102, a substitution of organic capping agents with inorganic capping agents 104 may take place. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction may rapidly produce insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystals, and inorganic capping agents may bind to that semiconductor nanocrystal surface. This process may continue until an equilibrium is established between inorganic capping agents and the free inorganic capping agents. Preferably, the equilibrium favors inorganic capping agents. All the steps described above may be carried out in a nitrogen environment inside a glove box.

The purification of inorganic capped semiconductor nanocrystals may require an isolation procedure, such as the precipitation of inorganic product. That precipitation permits one of ordinary skill to wash impurities and/or unreacted materials out of the precipitate. Such isolation may allow for the selective application of PCCN.

Preferred inorganic capping agents for PCCN may include polyoxometalates and oxometalates, such as tungsten oxide, iron oxide, gallium zinc nitride oxide, bismuth vanadium oxide, zinc oxide, titanium dioxide, among others.

Inorganic capping agents may include metals selected from transition metals. Additionally, inorganic capping agent may be Zintl ions. As used in the present disclosure, Zintl ions may refer to homopolyatomic anions and heteropolyatomic anions that may have intermetallic bonds between the same or different metals of the main group, transition metals, lanthanides, and/or actinides. Examples of Zintl ions may include: As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi 33-, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻, Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, mixed metal SnS₄Mn₂⁵⁻, among others. The positively charged counter ions may be alkali metal ions, ammonium, hydrazinium, tetraalkylammmonium, among others.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Still further, inorganic capping agents may include mixtures of Zintl ions and molecular compounds.

These inorganic capping agents further may include transition metal chalcogenides, examples of which may include the tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, such as MoS(Se₄)₂²⁻, Mo₂S₆²⁻, among others.

Method for forming a photoactive material 100 may be adapted to produce a wide variety of PCCN. Adaptations of this method for forming a photoactive material 100 may include adding two different inorganic capping agents to a single semiconductor nanocrystals (e.g., Au.(Sn₂S₆;In₂Se₄); Cu₂Se.(In₂Se₄;Ga₂Se₃)), adding two different semiconductor nanocrystals to a single inorganic capping agent (e.g., (Au;CdSe).Sn₂S₆; (Cu₂Se;ZnS).Sn₂S₆), adding two different semiconductor nanocrystals to two different inorganic capping agents (e.g., (Au;CdSe).(Sn₂S₆;In₂Se₄)), and/or additional multiplicities.

The sequential addition of inorganic capping agents to semiconductor nanocrystals may be possible under the disclosed method for forming a photoactive material 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable PCCN may include Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, FePt/PbTe.SnS₄, FePt/CdS.SnS₄, FePt/CdSe.SnS₄, FePt/CdTe.SnS₄, Au/PbS.In₂Se₄ Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

As used in the present disclosure, the denotation Au.Sn₂S₆ may refer to an Au semiconductor nanocrystal capped with a Sn₂S₆ inorganic capping agent. Charges on the inorganic capping agent are omitted for clarity. This notation [semiconductor nanocrystal]. [inorganic capping agent] is used throughout this description. The specific percentages of semiconductor nanocrystals and inorganic capping agents may vary between different types of PCCN.

Preparation of plasmonic nanoparticles 106 may be a process performed separately from reaction of semiconductor nano-precursors with organic solvents 102. According to various embodiments of the present disclosure, different methods known in the art for preparation of plasmonic nanoparticles 106 may be employed, which may vary according to the different materials and desired shapes of the noble metal nanoparticles to be used, reaction times, temperatures, and other factors. Nanoparticles of noble metals, such as Ag, Au, and Pt, may be used in preparation of plasmonic nanoparticles 106 because noble metal nanoparticles are capable of absorbing visible light due to their localized surface plasmon resonance, which may be tuned by varying their size, shape, and surrounding of the noble metal nanoparticles. Furthermore, noble metal nanoparticles may also work as an electron trap and active reaction sites, which may be beneficial in the use for photocatalytic reactions such as water splitting or CO₂ reduction.

Plasmonic nanoparticles may include any suitable shape, but generally shapes employed may include spherical (nanospheres), cubic (nanocubes), or wire (nanowires), among others. The shapes of these plasmonic nanoparticles may be obtained by various synthesis methods. For example, Ag plasmonic nanoparticles of various shapes may be formed by the reduction of silver nitrate with ethylene glycol in the presence of poly(vinyl pyrrolidone) (“PVP”). Ag nanocubes may be obtained by adding silver nitrate in ethylene glycol at a concentration of about 0.25 mol/dm³ and PVP in ethylene glycol at a concentration of about 0.375 mol/dm³ to etheylene glycol, previously heated, and allowing the reaction to proceed at a reaction temperature of about 160° C. The injection time may be of about 8 min, the unit of volume may be of about one milliliter (mL), and the reaction time may be of about 45 minutes.

According to embodiments of the present disclosure, approaches for preparation of plasmonic nanoparticles 106 may include depositing noble metal nanoparticles on the surface of a suitable polar semiconductor, such as AgCI, N—TiO₂ or AgBr, to form a metal-semiconductor composite plasmonic nanoparticle photocatalyst. In this embodiment, the noble metal nanoparticles may strongly absorb visible light, and the photogenerated electrons and holes of the noble metal nanoparticles may be efficiently separated by the metal-semiconductor interface.

As another example embodiment, a procedure for obtaining Au plasmonic nanoparticles embedded in SiO₂/TiO₂ thin films is described, where Au may function as the noble metal nanoparticle and SiO₂/TiO₂ as the semiconductors included in the plasmonic nanoparticles. In this embodiment, Au plasmonic nanoparticles may first be deposited onto a substrate, and the PCCN may be deposited subsequently. Initially, an ethanolic solution of the SiO₂/TiO₂ precursor and poloxamer (e.g. PluronicP123-poly(ethylene oxide)-poly(propylene oxide)-poly(ethyleneoxide) may be spin coated onto a Si or glass substrate. Then, a solution of HAuCl₄ may be deposited dropwise onto the surface and the sample may be spun again. Finally, the resulting film may be baked at about 350° C. for about 5 min. During the bake, a significant color change may take place because of the incorporation of Au nanoparticles in the host matrix.

The formation of inorganic matrices between the Au nanoparticle and the SiO₂/TiO₂ may be based on the acid-catalyzed hydrolytic polycondensation of metal alkoxides such as tetraethyl orthosilicate (SiO₂ precursor) and titanium tetrai-sopropoxide (TTIP; TiO₂ precursor) in the presence of a poloxamer, which may be used to achieve homogeneous, mesoporous spin-coated thin films. Moreover, the ploxoamer may play a key role on the incorporation of the AuCl₄-ions (Au nanoparticle precursor) into the host matrix because the PEO in poloxamer may form cavities (pseudo-crownethers) that may efficiently bind metal ions. Furthermore, the PEO and PPO blocks in poloxamer may act as reducing agents of AuCl₄ for the in situ synthesis of Au nanoparticles. Additionally, the formation of ethanol and isopropanol as byproducts of the respective TEOS (tetraethylorthosilicate, Si(OCH₂CH₃)₄ and TTIP polycondensations may also facilitate the reduction of Au(III).

The nanocomposite thin film formed by the above described method may have a surface roughness of about 10 to about 30 nm, depending on the size of Au nanoparticles produced in the metal oxide matrix, which may be determined by the concentration of Au(III) in the precursor solution.

After preparation of plasmonic nanoparticles 106, a deposition of PCCN between plasmonic nanoparticles 108 may take place. According to an embodiment, deposition of PCCN between plasmonic nanoparticles 108 may include first depositing plasmonic nanoparticles over a substrate, and then depositing the composition of PCCN over the substrate. According to another embodiment, PCCN may first be deposited over the substrate, followed by the deposition of PCCN over the substrate. According to yet another embodiment, both the composition of plasmonic nanoparticles and the composition of PCCN may be mixed and deposited over the substrate. Deposition methods over substrates may include spraying deposition, sputter deposition, electrostatic deposition, spin coating, inkjet deposition, laser printing (matrices), among others.

After both plasmonic nanoparticles and PCCN have been deposited over the substrate, a thermal treatment 110 may take place, which may result in the formation of a photoactive material for use in photoacatalytic reactions. Many of the inorganic capping agents used in PCCN may be precursors to inorganic materials (matrices), thus a low-temperature thermal treatment 110 of the inorganic capping agents employing a convection heater may provide a gentle method to produce crystalline films including both PCCN and plasmonic nanoparticles. Thermal treatment 110 may yield, for example, ordered arrays of semiconductor nanocrystals within an inorganic matrix, hetero-alloys, or alloys. In at least one embodiment, the convection heater may reach temperatures less than about 350, 300, 250, 200, and/or 180° C.

High Surface Area Substrate

FIG. 2 illustrates a wire mesh substrate 200 that may be used in a high surface area grid for the photoactive material. Wire mesh substrate may include two superimposed sheets having wires aligned in opposite direction to each other, vertically aligned wires 202 and horizontally aligned wires 204. Suitable materials for vertically aligned wires 202 and horizontally aligned wires 204 may include titanium dioxide, silver halides, graphene oxide, metallic materials such as aluminum alloys, stainless steel, and others.

Wire mesh substrate 200 size may vary according to the application, while distance between vertically aligned wires 202 and horizontally aligned wires 204 may range between about 10 nm and about 1 μm, where preferred distance may be between about 20 nm and about 50 nm. Diameter of the wires may be within a range of about 0.5 μm and about 10 μm.

FIG. 3 illustrates a high surface area grid 300 including wire mesh substrate 200 and piezoelectric actuators 302.

High surface area grid 300 may incorporate vertically aligned wires 202 and horizontally aligned wires 204 connected to piezoelectric actuators 302. Piezoelectric actuators 302 may be employed in order to control the dimensions of high wire mesh substrate 200 for increasing surface area.

Piezoelectric actuators 302 may be connected to wires using epoxy adhesives. Depending on the dimensions of vertically aligned wires 202 and horizontally aligned wires 204 and the suitable displacement of one wire from another, more than one piezoelectric actuator 302 may be employed. If more than one piezoelectric actuator 302 is employed they may be connected in series.

Suitable piezoelectric actuators 302 may include noliac stacked multilayer piezolectric actuators. Stacked multilayer piezoelectric actuators 302 may include two or several linear actuators glued together. The purpose of the stacking is to obtain more displacement that may be achieved by a single linear actuator. Piezoelectric actuators 302 may have a length ranging from about 2 mm to about 15 mm, a width between about 2 mm and about 15 mm, and a height within a range of about 4 mm and about 15 mm. The relationship of current and voltage for a piezoelectric actuator 302 may be calculated employing the following equation:

I=dQ/dt=C×dU/dt (1)

where:

I=current

Q=charge

C=capacitance

U=voltage

t=time

According to an embodiment, suitable minimum voltage for piezoelectric actuators 302 may be of about 60 V. Depending on the application, piezoelectric actuators may operate sinusoidally at a frequency from 0 Hz to about 100 Hz.

FIG. 3A shows vertically aligned wires 202 having two piezoelectric actuators 302, while FIG. 3B depicts horizontally aligned wires 204 with two piezoelectric actuators 302 attached along the sides.

Piezoelectric actuators 302 may allow a precise control of the displacement of the wires. Each wire may be individually controlled along the x, y, and/or z axis, thus allowing wires to get closer or further apart from each other, or to move up and down from each other. The ability to manipulate the distance between vertically aligned wires 202 and horizontally aligned wires 204 may enable an increase in the surface area available for light harvesting.

Plasmonic Nanoparticles and PCCN Alignment

FIG. 4 shows embodiments of alignment of plasmonic nanoparticles 400 within the photoactive material.

FIG. 4A shows plasmonic nanoparticles 402 in cubic shape exhibiting an edge-to-edge nanojunction employing ligands 404. FIG. 4B, plasmonic nanoparticles 402 in cubic shape exhibiting a face-to-face orientation, also employing ligands 404.

Benefits of using cubic shaped plasmonic nanoparticles 402 may include that cubes may be a compelling geometry for constructing non-close-packed nanoparticle architectures by coordination through facet, corner, or edge sites, and that this shape may support the excitation of higher-order surface plasmon modes that occur through charge localization into the corners and edges of the plasmonic nanoparticles 402. This excitation may enable orientation-dependent electromagnetic coupling between neighboring plasmonic nanoparticles 402, where interparticle junctions formed by cube corners and edges may produce intense electromagnetic fields that are confined below the conventional diffraction limit.

Different methods may be used to align plasmonic nanoparticles 402 in the desired manner. For example, to achieve an edge-to-edge nanojunction, cubic plasmonic nanoparticles 402 may be grafted with a long, floppy polymer ligand such as poly(vinyl pyrrolidone) (PVP, Mw ¼ 55,000) and embedded within a polystyrene (Mw ¼ 10,900) thin film with a thickness of about 150 nm. As the film is annealed using thermal or solvent vapor treatment, plasmonic nanoparticles 402 may assemble in the edge-to-edge alignment to form strings that may continuously grow and converge.

FIG. 5 shows different embodiments for positioning of PCCN between plasmonic nanoparticles 500 within the photoactive material.

FIG. 5A shows PCCN 502 in spherical shape positioned between plasmonic nanoparticles 402 in edge-to-edge nanojunction employing ligands 404. FIG. 5B shows PCCN 502 positioned between plasmonic nanoparticles 402 in face-to-face nanojunction employing ligands 404. Other arrangements, shapes, and different sizes and elements may be considered when depositing PCCN 502 between plasmonic nanoparticles 402. Additionally, methods other than binding PCCN 502 to plasmonic nanoparticles 402 with ligands 404 may be employed, including depositing PCCN 502 at stoichiometrically higher ratios so that statistics guides their chances of appropriate orientation.

Ligands 404 may be self-organizing molecules. For example, ligands 404 may be generated using self-assembling monolayer components. Typically, complementary binding pairs employed in ligands 404 are molecules having a molecular recognition functionality. For example, ligands 404 may include an amine-containing compound and a ketone or alcohol-containing compound.

Ligands 404 may be associated (either directly or indirectly) with any of a number of suitable nanostructure shapes and sizes, such as spherical, ovoid, elongated, or branched structures. Ligands 404 may either be directly associated with the surface of a nanostructure, or indirectly associated, through a surface ligand on the nanostructure; this interaction may be, for example, an ionic interaction, a covalent interaction, a hydrogen bond interaction, an electrostatic interaction, a coulombic interaction, a van der Waals force interaction, or a combination thereof. Optionally, the chemical composition of ligands 404 may include one or more functionalized head group capable of binding to a nanostructure surface, or to an intervening surface ligand. Chemical functionalities that may be used as a functionalized head group may include one or more phosphonic acid, carboxylic acid, amine, phosphine, phosphine oxide, carbamate, urea, pyridine, isocyanate, amide, nitro, pyrimidine, imidazole, salen, dithiolene, catechol, N,O-chelate ligand (such as ethanol amine or aniline phosphinate), P,N-chelate ligand, and/or thiol moieties.

Localized Surface Plasmon Resonance (LSPR)

FIG. 6 shows LSPR of photoactive material 600. Accordingly, PCCN 502 may be located between plasmonic nanoparticles 402 deposited over a high surface area grid 300 for forming a photoactive material 602.

When light 604 emitted from a light source 606 makes contact with plasmonic nanoparticles 402, oscillations of free electrons may occur as a consequence of the formation of a dipole moment in plasmonic nanoparticles 402 due to action of energy from electromagnetic waves of incident light 604. The electrons may migrate in plasmonic nanoparticles 402 to restore plasmonic nanoparticles 402 initial electrical state. However, light waves may constantly oscillate, leading to a constant shift in the dipole moment of plasmonic nanoparticles 402, thus electrons may be forced to oscillate at the same frequency as light 604, a process known as LSPR.

LSPR may only occur when frequency of light 604 is equal to or less than frequency of surface electrons oscillating against the restoring force of positive nuclei within plasmonic nanoparticles 402. LSPR is considered greatest at the electron plasma frequency of plasmonic nanoparticles 402, which is referred to as the resonant frequency. In plasmonic nanoparticles 402, the resonant frequency may be tuned by changing the geometry and size of plasmonic nanoparticles 402. The intensity of resonant electromagnetic radiation may be enhanced by several orders of magnitude near the surface of plasmonic nanoparticles 402. Additionally, LSPR of photoactive material 600 may create strong electric fields 608 between plasmonic nanoparticles 402. These electric fields 608 may closely interact with each other in adjacent plasmonic nanoparticles 402, which may increase formation of charge carriers for use in redox reactions for photocatalytic processes and enhance efficiency of these photocatalytic reactions.

Intensity of LSPR and electric field 608 may depend on wavelength of light 604 employed, as well as on materials, shapes, and sizes of plasmonic nanoparticles 402. These properties may be related to the densities of free electrons in the noble metals within plasmonic nanoparticles 402. Suitable materials used for plasmonic nanoparticles 402 may include those that are sensitive to visible light 604, although, according to other embodiments and depending on the wavelength of light 604, materials that are insensitive to visible light 604 may also be employed.

For example, the densities of free electrons in Au and Ag may be considered to be in the proper range to produce LSPR peaks in the visible part of the optical spectrum. For spherical gold and silver particles of about 1 to about 20 nm in diameters, only dipole plasmon resonance may be involved, displaying a strong LSPR peak of about 510 nm and about 400 nm, respectively.

According to various embodiments of the present disclosure, any suitable light source 606 may be employed to provide light 604. A suitable light source 606 may be sunlight, which includes infrared light, ultraviolet light and visible light. Sunlight may be diffuse, direct, or both. Light 604 may be filtered or unfiltered, modulated or unmodulated, attenuated or unattenuated. Light 604 may also be concentrated to increase the intensity using a light intensifier (not shown), which may include any combination of lenses, mirrors, waveguides, or other optical devices. The increase in the intensity of light 604 may be characterized by the intensity of light 604 having from about 300 to about 1500 nm (e.g., from about 300 nm to about 800 nm) in wavelength. A light intensifier may increase the intensity of light 604 by any factor, preferably by a factor greater than about 2, more preferably a factor greater than about 10, and most preferably a factor greater than about 25.

Plasmonic Photocatalysis

According to various embodiments, photoactive material 602 may have different photocatalytic applications, such as photocatalytic water splitting and CO₂ reduction. In an embodiment, photoactive material 602 may be submerged in water for redox reactions to occur that may result in the separation of hydrogen and oxygen molecules.

FIG. 7 shows water splitting 700 in which photoactive material 602 with high surface area grid 300 may be submerged in water 702 within a reaction vessel 704. When light 604 from light source 606 makes contact with plasmonic nanoparticles 402 and PCCN 502 within photoactive material 602, redox reactions may take place in which a charge separation process may occur (explained in FIG. 8). This charge separation may result in electrons reducing hydrogen molecules 706 and oxygen molecules 708 being oxidized by holes.

The ability to control the displacement of the wires within high surface area grid 300 may enable neighboring wires to come closer together, which may be done when light 604 is intense or is being focused to a small area with high photon flux, such that a high density of wires may be desired to harvest as much light 604 as possible. Separating the wires from neighboring wires may be required when light 604 is sufficient, increasing the available surface area for photocatalytic reactions.

Piezoelectric actuators 302 may also enable the vibration of high surface area grid 300 at a suitable frequency. The vibration may agitate water 702 in contact with high surface area grid 300, which may renew water 702 as a resource during photocatalysis. The vibration may also help to dislodge any bubble formation occurring at the interface which may be blocking photocatalytic production.

According to various embodiments, one or more walls of reaction vessel 704 may be formed of glass or other transparent material, so that light 604 may enter reaction vessel 704. It is also possible that most or all of the walls of reaction vessel 704 are transparent such that light 604 may enter from many directions. In another embodiment, reaction vessel 704 may have one side which is transparent to allow the incident radiation to enter and the other sides may have a reflective interior surface which reflects the majority of the solar radiation.

Photoactive material 602 may additionally be employed for other applications, including CO₂ reduction.

FIG. 8 shows charge separation 800 that may occur during water splitting 700.

In FIG. 8A, when light 604 with a frequency that is equal to or less than frequency of surface electrons 802 oscillating against the restoring force of positive nuclei within plasmonic nanoparticles 402 makes contact with plasmonic nanoparticles 402, and with energy equal to or greater than that of band gap 812 of plasmonic nanoparticles 402, electrons 802 may be excited and may migrate from valence band 804 of plasmonic nanoparticles 402 to conduction band 806 of PCCN 502. This process may be triggered by photo-excitation 808 and enhanced by the rapid electron 802 resonance from LSPR.

In FIG. 8B, when electrons 802 are in conduction band 806 of PCCN 502, electrons 802 may reduce hydrogen molecules 706 from water 702, while oxygen molecules 708 may be oxidized by holes 810 left behind in valence band 804 of plasmonic nanoparticles 402. Accordingly, in order for water splitting 700 to take place, photo-excited electrons 802 from plasmonic nanoparticles 402 may need to have a reduction potential greater than or equal to that necessary to drive the following reaction:

2H₃O⁺+2e⁻→H₂+2H2O (1)

This reaction has a standard reduction potential of 0.0 eV vs. the standard hydrogen electrode (SHE), or standard hydrogen potential of 0.0 eV. Hydrogen molecules 706 (H₂) in water 702 may be reduced when receiving two electrons 802. On the other hand, holes 810 should have an oxidation potential greater than or equal to that necessary to drive the following reaction:

6H₂O+4h⁺→O₂+4H₃O⁺ (2)

That reaction may exhibit a standard oxidation potential of −1.23 eV vs. SHE. Oxygen molecules 708 (O₂) in water 702 may be oxidized by four holes 810. Therefore, the minimum band gap 812 for plasmonic nanoparticles 402 in water splitting 700 is 1.23 eV. Given overpotentials and loss of energy for transferring the charges to donor and acceptor states, the minimum energy may be closer to 2.1 eV.

Electrons 802 may acquire energy corresponding to the wavelength of the absorbed light 604. Upon being excited, electrons 802 may relax to the bottom of conduction band 806 of plasmonic nanoparticles 402, which may lead to recombination with holes 810 and therefore to an inefficient process for water splitting 700. For an efficient charge separation 800, reactions have to take place to quickly sequester and hold electrons 802 and holes 810 for use in subsequent redox reactions used for water splitting 700. For this purpose, the combined use of plasmonic nanoparticles 402 with enhanced electric fields 608 and LSPR, and the use of efficient PCCN 502 for accelerating redox reactions may prevent recombination of charge carriers and may lead to an enhanced water splitting 700.

Band gap 812 of energy of quantum-confined plasmonic nanoparticles 402 and PCCN 502 may be strongly size-and-shape dependent since these effects may determine absolute positions of the energy quantum-confined states in both plasmonic nanoparticles 402 and PCCN 502. The ability to efficiently inject or extract charge carriers may depend on the energy barriers that form at the interfaces between individual plasmonic nanoparticles 402 and also at the interface between PCCN 502 and plasmonic nanoparticles 402. If contacts do not properly align, a potential barrier may form, leading to poor charge injection and nonohmic contacts.

System Configuration and Functioning

FIG. 9 shows a water splitting system 900 employing water splitting 700.

A continuous flow of water 702 as gas or liquid may enter reaction vessel 704 through a nozzle 902. Subsequently, water 702 may pass through a region including photoactive material 602 illuminated by light 604 emitted by light source 606 for water splitting 700 occur. Water splitting system 900 may additionally include a light intensifier 904 for concentrating light 604 and increasing efficiency of water splitting 700. Subsequently, water 702 may exit through a filter 906. Water 702 coming through nozzle 902 may also include hydrogen gas 908, oxygen gas 910 and other gases such as an inert gas or air. According to an embodiment, water 702 entering reaction vessel 704 may include recirculated gas removed from reaction vessel 704 and residual water 702 which did not react in reaction vessel 704 along with hydrogen gas 908 and oxygen gas 910, as well as any other gas in water splitting system 900. Preferably, a heater 912 may be connected to reaction vessel 704 to produce heat 914 so that water 702 may boil, assisting on the extraction of hydrogen gas 908 and oxygen gas 910 through filter 906. Heater 912 may be powered by different energy supplying devices. Preferably, heater 912 may be powered by renewable energy supplying devices, such as photovoltaic cells, or by energy stored employing the system and method from the present disclosure. Materials for the walls of reaction vessel 704 may be selected based on the reaction temperature.

Filter 906 may allow the exhaust of water 702 from reaction vessel 704 while trapping certain impurities from water 702. Filter 906 may permit the passage of hydrogen gas 908, oxygen gas 910, and water 702 which may subsequently flow through exhaust tube 916.

After passing through reaction vessel 704, water 702, hydrogen gas 908, and oxygen gas 910 may be transferred through exhaust tube 916 to a collector 918 which may include a reservoir 920 connected to a hydrogen permeable membrane 922 (e.g. silica membrane) and an oxygen permeable membrane 924 (e.g. silanized alumina membrane) for collecting hydrogen gas 908 and oxygen gas 910 to be stored in tanks or any other suitable storage equipment. Collector 918 may also be connected to a recirculation tube 926 which may transport remaining exhaust gas 928 back to nozzle 902 to supply additional water 702 to reaction vessel 704. Additionally, remaining exhaust gas 928 may be used to heat water 702 entering nozzle 902. The flow of hydrogen gas 908, oxygen gas 910 and water 702 in water splitting system 900 may be controlled by one or more pumps 930, valves 932, or other flow regulators.

FIG. 10 depicts energy generation system 1000 that may be used to generate and store hydrogen gas 908 and oxygen gas 910 for use in a hydrogen fuel cell 1002 (explained in detail in FIG. 11), generating electricity that may be employed in one or more electrically driven applications 1004, electric grids 1006, batteries 1008, among others.

Hydrogen gas 908 and oxygen gas 910 resulting from water splitting system 900 may be stored in hydrogen storage 1010 and oxygen storage 1012. Hydrogen gas 908 and oxygen gas 910 may then be collected in a collector 918 and combined in a hydrogen fuel cell 1002 that may produce water 702 vapor or liquid and electricity, the latter of which may be provided to an electric grid 1006, used in an electrically driven application 1004 (e.g. a motor, light, heater, pump, amongst others), stored in a battery 1008, or any combination thereof.

According to another embodiment, electricity may be produced by burning hydrogen gas 908 to produce steam and then generating electricity 1102 using a steam Rankine cycle-generator set.

Energy generation system 1000 may be mounted on a structure such as the roof of a building, or may be free standing, such as in a field. Energy generation system 1000 may be stationary, or may be on a mobile structure (e.g. a transportation vehicle, such as a boat, an automotive vehicle, and farming machinery). The mounting of energy generation system 1000 may include elements for adjusting the positioning of reaction vessel 704, light intensifier 904 or both, such that the intensity of intensified light 604 in reaction vessel 704 may be increased. For example, light intensifier 904 may be adjusted to track the position sunlight. Such adjustments to the position of light intensifier 904 may be made to accommodate seasonal or daily positioning of the sun. The adjustments may be made frequently throughout the day.

FIG. 11 depicts a hydrogen fuel cell 1002 that may be used for mixing hydrogen gas 908 and oxygen gas 910 for the production of electricity 1102 and water 702. Hydrogen fuel cell 1002 may include two electrodes, an anode 1104 making contact with hydrogen gas 908, and a cathode 1106 making contact with oxygen gas 910, separated by an electrolyte 1108 that may allow charges to move between both sides of hydrogen fuel cell 1002. Electrolyte 1108 is electrically insulating, specifically designed so protons 1110 (H⁺) may may pass through, but electrons 802 (e−) may not.

At anode 1104, a catalyst oxidizes incoming hydrogen gas 908, forming hydrogen protons 1110 and electrons 802. Hydrogen gas 908 that has not reacted with the catalyst in anode 1104 may leave hydrogen fuel cell 1002 via hydrogen exhaust 1112. Freed electrons 802 may travel through a conductor such as a wire (not shown) creating electricity 1102 that may be used to power electrically driven applications 1004, while protons 1110 may travel through electrolyte 1108 to cathode 1106. Once reaching cathode 1106, hydrogen protons 1110 may reunite with electrons 802, subsequently reacting and combining with oxygen gas 910, to produce water 702.

### Examples

Example #1 shows an embodiment of PCCN 502 in spherical shape 1200, as shown in FIG. 12, which may include a single semiconductor nanocrystal 1202 capped with a first inorganic capping agent 1306 and a second inorganic capping agent 1308.

In an embodiment, single semiconductor nanocrystal 1202 may be PbS quantum dots, with SnTe₄⁴⁻ used as first inorganic capping agent 1306 and AsS₃³⁻ used as second inorganic capping agent 1308, therefore forming a PCCN 502 represented as PbS.(SnTe₄;AsS₃).

The shape of semiconductor nanocrystals 1202 may improve photocatalytic activity of semiconductor nanocrystals 1202. Changes in shape may expose different facets as reaction sites and may change the number and geometry of step edges where reactions may preferentially take place.

Example #2 shows an embodiment of PCCN 502 in nanorod shape 1300, as shown in FIG. 13. According to an embodiment, there may be three CdSe regions and four CdS regions as first semiconductor nanocrystal 1302 and second semiconductor nanocrystal 1304, respectively. In addition, first semiconductor nanocrystal 1302 and second semiconductor nanocrystal 1304 may be capped with first inorganic capping agent 1306 and second inorganic capping agent 1308, respectively. Each of the three CdSe first semiconductor nanocrystal 1302 regions may be longer than each of the four CdS second semiconductor nanocrystal 1304 regions. In other embodiments, the different regions with different materials may have the same or different lengths, and there may be any suitable number of different regions. The number of segments per nanorod in nanorod shape 1300 may generally increase by increasing the length of the nanorod or decreasing the spacing between like segments.

Example #3 is an embodiment in which photoactive material 602 with high surface area grid 300 is employed for CO2 reduction 1400 for producing methane molecules 1402 and water 702, as shown in FIG. 14. Accordingly carbon dioxide 1404 may be introduced into reaction vessel 704 via inlet line 1406. Similarly, hydrogen gas 908 may be injected into reaction vessel 704 by inlet line 1406.

Light 604 from light source 606 may be intensified by light intensifier 904, which may reflect light 604 and may direct light 604 into reaction vessel 704 through window 1408. In addition, light 604 may be reflected into reaction vessel 704 by light reflector 1410 to increase light extraction efficiency. Carbon dioxide 1404 and hydrogen gas 908 may pass through photoactive material 602 prior to entering reaction vessel 704. Light 604 may react with photoactive material 602 to produce charge separation 800 in the boundary of photoactive material 602. Carbon dioxide 1404 may be reduced and hydrogen gas 908 may be oxidized by a series of reactions until methane molecule 1402 and water 702 are produced.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

While various aspects and embodiments have been disclosed, other aspects and embodiments are contemplated. The various aspects and embodiments disclosed are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

What's claimed is:

1. A photoactive material comprising:
a substrate, wherein the substrate comprises:
a first set of substantially parallel wires extending in a first direction;
a first piezoelectric actuator coupled to the first set of wires at a first end of the first set of wires;
a second piezoelectric actuator coupled to the first set of wires at a second end of the first set of wires;
a second set of substantially parallel wires extending in a second direction that is perpendicular to the first direction;
a third piezoelectric actuator coupled to the second set of wires at a first end of the second set of wires; and
a fourth piezoelectric actuator coupled to the second set of wires at a second end of the second set of wires;
a plurality of plasmonic nanoparticles deposited on the substrate, wherein the plasmonic nanoparticles create an electric field between two adjacent plasmonic nanoparticles when absorbing light; and
a plurality of photocatalytic capped colloidal nanocrystals deposited on the substrate, wherein each photocatalytic capped colloidal nanocrystal is deposited between at least two plasmonic nanoparticles.

2. The photoactive material of claim 1, wherein the first and second set of wires include at least one selected from the group consisting of titanium dioxide, silver halides, graphene oxide, or a metallic material.

3. The photoactive material of claim 1, wherein the first, second, third, and fourth piezoelectric actuators control the displacement of adjacent wires of the first and second set of wires and the distance between the first set of wires and the second set of wires.

4. The photoactive material of claim 1, wherein each of the first, second, third, and fourth piezoelectric actuators is Noliac stacked multilayer piezoelectric actuators.

5. The photoactive material of claim 1, wherein a distance between adjacent wires in the first and second set of wires ranges from 10 nm to 1.0 μm.

6. The photoactive material of claim 1, wherein the first, second, third, and fourth piezoelectric actuators operate sinusoidally at a frequency ranging from 0 to 100 Hz.

7. The photoactive material of claim 1, wherein each of the first, second, third, and fourth piezoelectric actuators has a minimum driving voltage of 60 V.

8. The photoactive material of claim 1, wherein the first, second, third, and fourth piezoelectric actuators move the first and second set of wires up and down relative to each other.

9. The photoactive material of claim 1, wherein the first and second set of wires and first, second, third, and fourth piezoelectric actuators form a high surface area grid.

10. The photoactive material of claim 1, further comprising:
ligands forming a nanojunction between the plasmonic nanoparticles and the photocatalytic capped colloidal nanocrystals.

11. The carbon dioxide reduction system of claim 1, wherein the photocatalytic capped colloidal nanocrystals comprise a first semiconductor nanocrystal capped with a first inorganic capping agent.

12. The carbon dioxide reduction system of claim 4, wherein the photocatalytic capped colloidal nanocrystals further comprise a second semiconductor nanocrystal capped with a second inorganic capping agent.

13. The photoactive material of claim 1, wherein the photocatalytic capped colloidal nanocrystals comprises a compound selected from a group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄ FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

14. The photoactive material of claim 1, wherein the plasmonic nanoparticles include a noble metal.

15. The photoactive material of claim 1, wherein the substrate is a transparent substrate.

16. The photoactive material of claim 1, wherein the electric field created between two adjacent plasmonic nanoparticles causes electrons in a valence band of the plasmonic nanoparticles to migrate to a conduction band of the photocatalytic capped colloidal nanocrystals when light contacts the plasmonic nanoparticles, and the electrons in the conduction band of the photocatalytic capped colloidal nanocrystals are used for a reduction reaction.

17. A water splitting system comprising:
a photoactive material, wherein the photoactive material comprises:
a substrate, wherein the substrate comprises:
a first set of substantially parallel wires extending in a first direction;
a first piezoelectric actuator coupled to the first set of wires at a first end of the first set of wires;
a second piezoelectric actuator coupled to the first set of wires at a second end of the first set of wires;
a second set of substantially parallel wires extending in a second direction that is perpendicular to the first direction;
a third piezoelectric actuator coupled to the second set of wires at a first end of the second set of wires; and
a fourth piezoelectric actuator coupled to the second set of wires at a second end of the second set of wires;
a plurality of plasmonic nanoparticles deposited on the substrate, wherein the plasmonic nanoparticles create an electric field between two adjacent plasmonic nanoparticles when reacting to received light; and
a plurality of photocatalytic capped colloidal nanocrystals deposited on the substrate, wherein each photocatalytic capped colloidal nanocrystal is deposited between at least two plasmonic nanoparticles;
a reaction vessel housing the photoactive material and configured to receive water through a nozzle and facilitate a water splitting reaction when the water reacts with the photocatalytic capped colloidal nanocrystals and plasmonic nanoparticles, wherein the reaction occurs when the plasmonic nanoparticles absorb irradiated light that causes electrons in the valence band of the plasmonic nanoparticles to migrate into the conduction band of the photocatalytic capped colloidal nanocrystals, and the electrons in the conduction band of the photocatalytic capped colloidal nanocrystals are used to reduce water into hydrogen gas and oxygen gas;
a collector connected to the reaction vessel and comprising:
a hydrogen-permeable membrane configured to separate the hydrogen from the oxygen in the collector, wherein the hydrogen passes through the hydrogen-permeable membrane into a hydrogen storage; and
a oxygen-permeable membrane configured to separate the oxygen from the hydrogen in the collector, wherein the oxygen passes through the oxygen-permeable membrane into an oxygen storage; and
a fuel cell configured to mix the hydrogen gas received from the hydrogen storage and the oxygen gas received from the oxygen storage to produce water and electricity.

18. The water splitting system of claim 19, wherein the photocatalytic capped colloidal nanocrystals comprise a first semiconductor nanocrystal capped with a first inorganic capping agent.

19. The water splitting system of claim 19, wherein the photocatalytic capped colloidal nanocrystals further comprise a second semiconductor nanocrystal capped with a second inorganic capping agent.

20. The water splitting system of claim 21, wherein the first inorganic capping agent is a reduction photocatalyst and the second inorganic capping agent is an oxidation photocatalyst.

21. The water splitting system of claim 19, wherein at least a portion of the reaction vessel is formed of a transparent material.

22. The water splitting system of claim 19, further comprising:
a light intensifier that intensifies the intensity of the light before the light is absorbed by the photoactive material.

23. The water splitting system of claim 24, wherein the light intensifies is adjusted with the position of the sun.

24. The water splitting system of claim 19, wherein the plasmonic nanoparticles include a noble metal.

25. The water splitting system of claim 19, wherein the first, second, third, and fourth piezoelectric actuators control the displacement of adjacent wires of the first and second set of wires and the distance between the first set of wires and the second set of wires.

26. A carbon dioxide reduction system comprising:
a photoactive material, wherein the photoactive material comprises:
a substrate, wherein the substrate comprises:
a first set of substantially parallel wires extending in a first direction;
a first piezoelectric actuator coupled to the first set of wires at a first end of the first set of wires;
a second piezoelectric actuator coupled to the first set of wires at a second end of the first set of wires;
a second set of substantially parallel wires extending in a second direction that is perpendicular to the first direction;
a third piezoelectric actuator coupled to the second set of wires at a first end of the second set of wires; and
a fourth piezoelectric actuator coupled to the second set of wires at a second end of the second set of wires;
a plurality of plasmonic nanoparticles deposited on the substrate, wherein the plasmonic nanoparticles create an electric field between two adjacent plasmonic nanoparticles when absorbing light; and
a plurality of photocatalytic capped colloidal nanocrystals deposited on the substrate, wherein each photocatalytic capped colloidal nanocrystal is deposited between at least two plasmonic nanoparticles;
a reaction vessel housing the photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction occurs when the plasmonic nanoparticles absorb irradiated light that causes electrons in the valence band of the plasmonic nanoparticles to migrate into the conduction band of the photocatalytic capped colloidal nanocrystals; and
a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

27. The carbon dioxide reduction system of claim 28, further comprising:
a light intensifier that intensifies the intensity of the light before the light is absorbed by the photoactive material.

28. The carbon dioxide reduction system of claim 28, wherein the plasmonic nanoparticles include a noble metal.

29. The carbon dioxide reduction system of claim 28, wherein the photocatalytic capped colloidal nanocrystals comprise a first semiconductor nanocrystal capped with a first inorganic capping agent.

30. The carbon dioxide reduction system of claim 28, wherein the photocatalytic capped colloidal nanocrystals further comprise a second semiconductor nanocrystal capped with a second inorganic capping agent.
